(19) United States
(12) Patent Application Publication
(10) Pub. No.: US 2007/0214384 A1
(43) Pub. Date: Sep. 13, 2007

(54) Method for backing up data in a clustered file system

(76) Inventor: Manabu Kitamura, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/368,444

(22) Filed: Mar. 7, 2006

(51) Int. Cl. G06F 11/00

(52) U.S. Cl. 714/13

(57) ABSTRACT

In a clustered file system or clustered NAS having a single namespace, data backup may be performed with only one backup request from a client host. When a backup request is received at one file server, that file server backs up data, if needed, and sends another backup request to another file server that also manages data in the namespace. This process is repeated until the backup process is completed. Similarly, during restore operations, when a restore request is received, the file server that receives the restore request issues additional restore requests to other file servers that manage data that is also requested to be restored.

### BACKGROUND OF THE INVENTION

1. Field of the Invention

The present invention relates generally to methods of backing up storage systems. In particular, the present invention relates to backing up of clustered file servers having multiple host interfaces and processors.

2. Description of Related Art

Clustering is the use of multiple computers, multiple storage devices, and redundant interconnections, to form what appears to users as a single highly-available system. Clustering can be used for load balancing as well as for high availability. A clustered file system (clustered Network Attached Storage (NAS)) includes a plurality of file systems, and creates at least one single namespace. A namespace is a set of valid names recognized by a file system that identifies the directory tree structure of the directories and file path names that combine to form a complete file system. The file system imposes structure on the address space of one or more physical or virtual disks so that applications may deal more conveniently with abstractly-named data objects of variable size, i.e., files. In a clustered file system, the file system (sometimes referred to as a “global file system”) may be distributed across multiple NAS devices, while appearing to a user as a complete single file system located on a single device. In the global file system, the namespace (or directory tree) of the file system may extend across multiple file servers or NAS systems. One method of achieving this under the Network File System (NFS) version 4 protocol involves providing network file system software on the NAS hosts whereby referrals on one host indicate the storage location of directories and files on another host.

Often, NAS systems may be heterogeneous, wherein the NAS hosts provide file services to distributed systems that may be running different operating systems or network protocols (i.e., a heterogeneous network). A standard backup protocol for a heterogeneous NAS system is referred to as Network Data Management Protocol (NDMP), which defines a common architecture for the way heterogeneous file servers on a network are backed up. This protocol (e.g., NDMP Version 4) is supported by most NAS systems for backing-up data (see, e.g., www. ndmp.org/download/sdk_v4/draft-skardal-ndmp4-04.doc). The NDMP protocol defines a mechanism and protocol for controlling backup, recovery, and other transfers of data between primary and secondary storages. The protocol will allow the creation of a common agent used by the central back-up application to back up different file servers running different platforms and platform versions. With NDMP, network congestion is minimized because the data path and control path are separated. Back up can occur locally from file servers directly to tape drives, while management can occur from a central location.

However, the NDMP protocol does not disclose how to backup data in a plurality of file systems using a single operation. Rather, when using NDMP for the backup operations, the backup programs that support NDMP have to issue a backup request in each file system. When NDMP is applied to a clustered NAS or a clustered file system, even if there is a single namespace, the backup program has to issue a plurality of backup requests due to there being a plurality of NAS hosts. Therefore, from the perspective of a user or client host, issuing a plurality of backup requests is a non-intuitive operation given that in the clustered NAS or clustered file system the file system is presented to the user as a single file system. This leads to an inconvenience and burden placed on the user or host that the present invention seeks to avoid.

Examples of prior art include Mike Kazar, “Spinserver Systems and Linux Compute Farms”, NetApp Technical Report White Paper, Network Appliance Inc., February 2004, www.netapp.com/tech_library/3304.html; Amina Saify et al., “Achieving Scalable I/O Performance in High-Performance Computing Environments”, Dell Power Solutions, February 2005, pp. 128-132, www.ibrix.com/dell_saify.pdf; and U.S. Pat. No. 6,782,389 to Chrin et al. These prior art documents provide general introductions to clustered file systems or clustered NAS. However, these documents do not disclose how to backup data in a clustered file system or clustered NAS environment.

Additionally, an updated Network File System (NFS) protocol, NFSv4 has been proposed (see, e.g., “NFS version 4 Protocol”, www.ietf.org/rfc/rfc3530.txt). However, while the NFSv4 protocol sets forth a “migration function”, this protocol also does not disclose any backup method in a clustered file system or clustered NAS environment.

### BRIEF SUMMARY OF THE INVENTION

Under the present invention, the backup operation for users or client hosts in clustered file systems is simplified. According to one aspect, the storage system has a plurality of file servers, a plurality of storage volumes, and interconnecting means to connect the plurality of file servers and plurality of storage volumes. Each file server manages at least its own local file system and constructs a single namespace from a plurality of local file systems in other file servers. Upon receipt of a backup request at a particular file server, that particular file server issues backup requests to other file servers.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a file server system according to an embodiment of the present invention.

FIG. 2 illustrates a functional diagram of the file server system of FIG. 1.

FIG. 3 illustrates an example of file system data.

FIG. 4A illustrates an example a single directory tree or single namespace of the present invention.

FIG. 4B illustrates how a file server determines whether files/directories to be accessed are managed within the file server or other file servers.

FIG. 5 illustrates an example of data back-up in a tape device according to the prior art.

FIG. 6 illustrates an example of data back-up in a tape device according to an embodiment of the present invention.

FIG. 7 illustrates an example of the format of the archived file according to an embodiment of the present invention.

FIGS. 8-10 illustrate the process flow of performing a back-up operation according to an embodiment of the present invention.

FIGS. 11-12 illustrate a flowchart of the operation of restoring files or directories according to an embodiment of the present invention.

FIG. 13 illustrates another example of a single directory or single namespace according to another embodiment of the present invention.

FIG. 14 illustrates an example of the format of the archived file according to another embodiment of the present invention.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention or this application in any fashion.

### FIRST EMBODIMENT

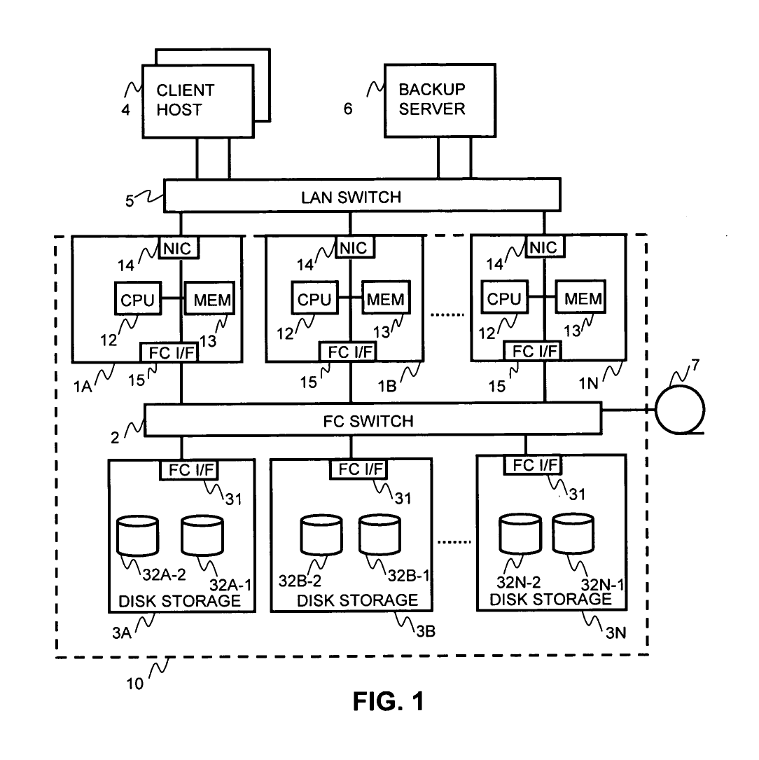

FIG. 1 illustrates an example configuration of a file server system 10 according to a first embodiment of the present invention. File server system 10 has a plurality of file servers 1A, 1B . . . 1N connected via a Fibre Channel (FC) switch 2 to a plurality of disk storages 3A, 3B . . . 3N. Each file server 1A-1N has a Network Interface Controller (NIC) 14 that is used for interconnecting with other file servers 1 via Ethernet connection, or the like, and for receiving file access requests from one or more client hosts 4. Each file server 1A-1N also includes a CPU 12, a memory 13 and a FC interface 15. Programs handling file access requests on file servers 1A-1N use CPU 12 and memory 13.

Each disk storage 3A-3N has a FC interface 31, and disks 32A-1 to 32N-1 and 32A-2 to 32N-2. These disks may be hard disk drives or logical devices arranged and operable using a RAID (redundant arrays of independent disks) technique or other configurations. Client hosts 4 are typical PC/AT based architecture running UNIX or Windows operating systems, or the like. Client hosts 4 issue file access requests such as Network File System (NFS) or Common Interface File System (CIFS) protocol requests to file servers 1A-1N via a LAN switch 5 (e.g., an Ethernet switch).

A backup server 6 is provided to manage backup and restore operations for the file servers 1A-1N and is also connected to LAN switch 5. The hardware architecture of backup server 6 can be similar to the client hosts 4 or may be of a different hardware architecture. Backup device 7 may be a magnetic tape drive, magnetic tape library apparatus, optical disk drive, optical disk library or other type of storage device. Backup device 7 is connected to FC switch 2 such that it can be accessed by each file server 1A-1N using FC protocol.

According to one embodiment, file servers 1A-1N, FC switch 2 and disk storages 3A-3N are stored in a single cabinet. Alternatively, each of these elements may be placed at different locations. The number of file servers 1A-1N and the number of disk storages 3A-3N is variable and their numbers may not necessarily be equal to each other as in the exemplary illustration of FIG. 1.

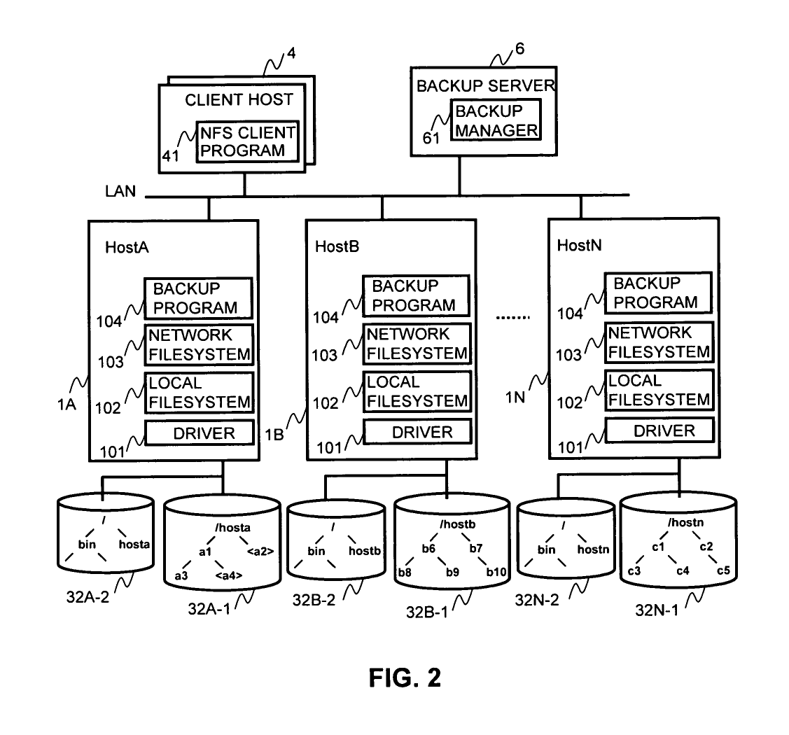

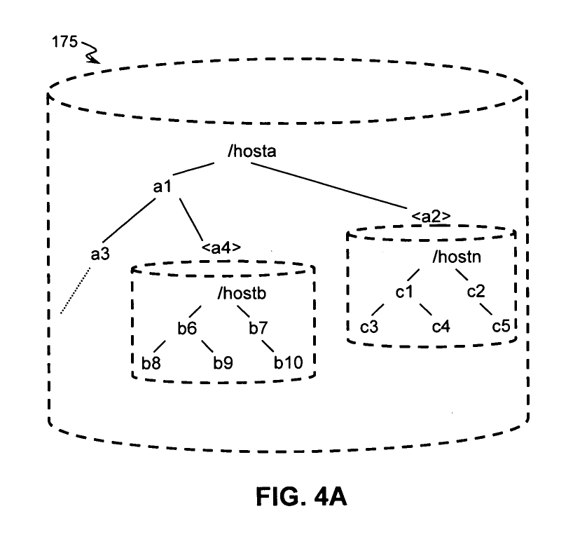

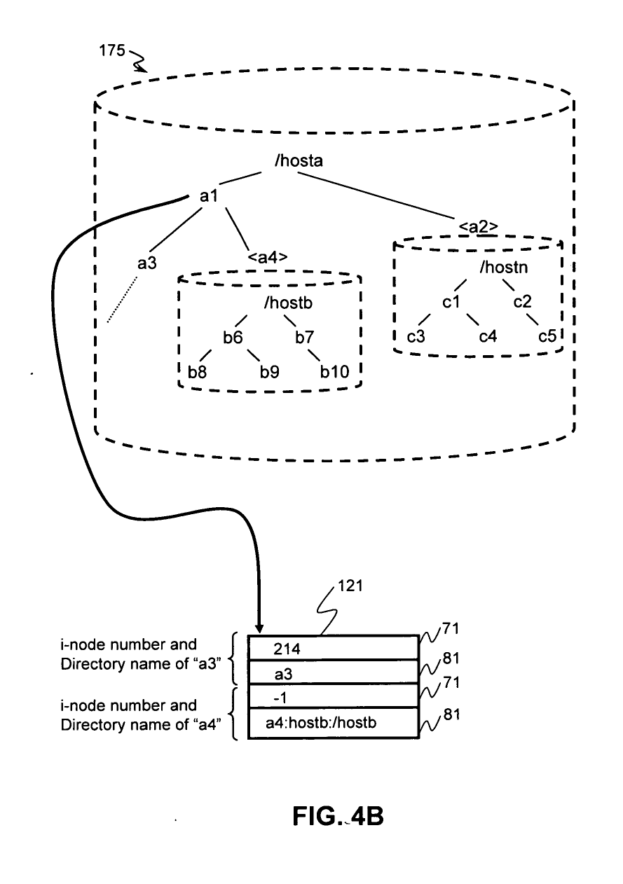

FIG. 2 illustrates a functional diagram of the file server system 10. In each file server (host) 1A-1N, there is a driver 101, a local file system 102, a network file system 103, and a backup program 104. The driver 101 and local file system 102 are used to access disks 32A-1 to 32N-1 and disks 32A-2 to 32N-2 in disk storages 3A-3N. Network file system 103 processes file access requests from client host 4 in accordance with network file system (NFS) or common internet file system (CIFS) protocol. Each network file system 103 communicates with other network file systems of other file servers so as to show the client host a single directory tree. The single directory tree resulting from the structure shown in FIG. 2 is shown and discussed in more detail in connection with FIG. 4A. Additionally, client host 4 has an NFS client program 41 which converts a request in accordance with NFS protocol to each file server 1A-1N.

According to the present embodiment, even though each file server 1A-1N is physically connected with each disk storage 3A-3N, the file server only accesses one of the disk storages 3A-3N. File server 1A accesses storage system 3A, file server 1B accesses storage system 3B, and file server 1N accesses storage system 3N. However, according to a different embodiment, each file server 1A-1N may access all of the disk storages 3A-3N.

Under the invention, backup program 104 receives a backup or restore request from a backup manager 61 that resides on backup server 6. In response, backup program 104 executes backup/restore operations in the file system data of each file server 1A-1N, respectively, as will be discussed in greater detail below. The backup program 104 may reside in memory 13, be stored on disk, or be stored on other computer readable medium on the backup server 6. In another embodiment, the backup program 104 may reside in one of the client hosts 4 with NFS client program 41.

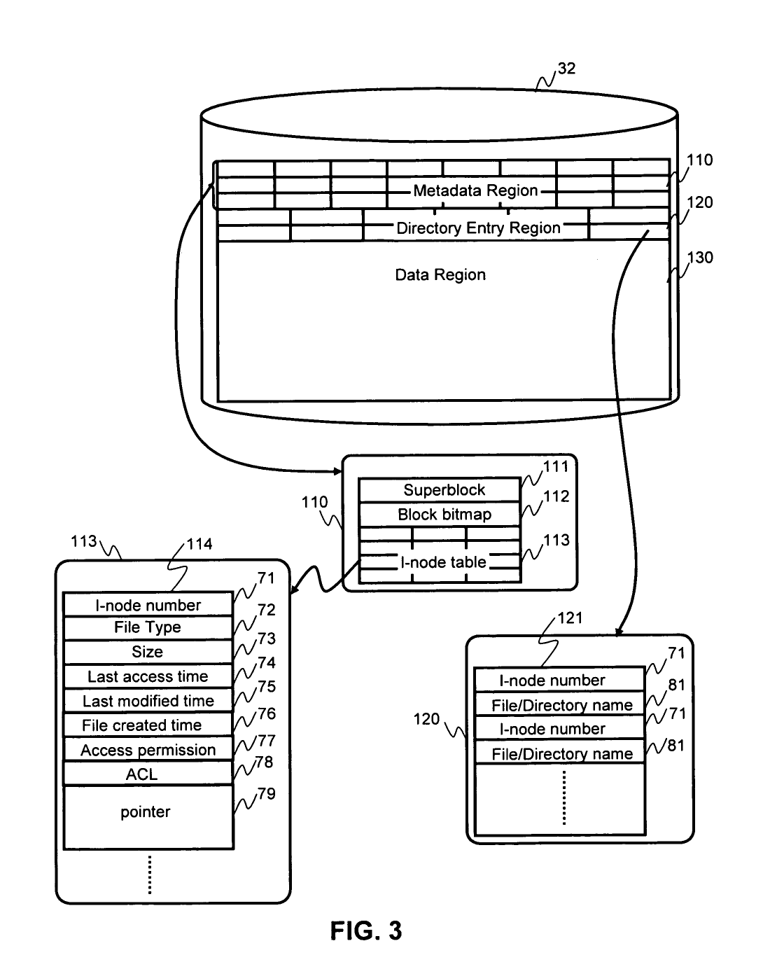

The local file system 102 of each file server 1A-1N creates a data structure in each disk 32 (corresponding to disks 32A-1 to 32N-1 and disks 32A-2 to disk 32N-2) so that one or more files or directories can be managed on each disk. This may be referred to as file system data. An example of such a data structure of file system data is illustrated in FIG. 3. As illustrated in FIG. 3, disk 32 has a metadata region 110, a directory entry region 120 and a data region 130. Metadata region 110 includes a superblock 111, a block bitmap 112 and an i-node table 113. The i-node table 113 typically includes a plurality of sets of information of each file or directory, such as location of the file, size of the file, and so on. The set of information of the file is called i-node 114. Each i-node includes at least i-node number 71, file type 72, file size 73, last access time 74, last modified time 75, file created time 76, access permission 77, ACL 78 and pointer 79 that indicates a disk block address where the file is stored. Each i-node 114 can be used to indicate a file or a directory. If the i-node indicates a file (if its file type field 72 is “file”, the data block pointed to from the pointer in the i-node contains actual data of the file. If a file is stored in a plurality of blocks (such as ten blocks), the addresses of the ten disk blocks are recorded in block pointer 79. On the other hand, if the i-node 114 is for a directory, then the file type field 72 is “directory”, and the data blocks pointed to from block pointer 79 store a list of i-node numbers and names of all files and directories (subdirectories) in the directory (i.e. directory entry 121).

Additionally, directory entry region 120 is composed of a plurality of directory entries 121. Each directory entry 121 corresponds to a directory in the file system data, and each directory entry 121 includes i-node number 71 and file/directory name 81 that are located under the directory. According to the present embodiment, each local file system of each file server 1A-1N maintains two file system data: a first file system data to store the binary files or the configuration files in each file server 1A-1N; and a second file system data to store the data from client hosts 4. For example, in file server 1A, the file system data to store the binary or the configuration files (the programs that work in the file server 1A such as local filesystem 102, backup program 104, and so on) is maintained in the disk 32A-2, and the file system data to store data from client hosts 4 is maintained in the disk 32A-1. As for the file system data to store data from client hosts 4, file server 1A maintains the directory tree that starts from “/hosta” (e.g. file server 1A mounts the file system data in the disk 32A-2 under the directory “/hosta”, where is under the root directory “/” in the file system data in the disk 32A-1), file server 1B maintains the directory tree that starts from “/hostb”, and file server 1N maintains the directory tree that starts from “/hostN”.

Network file system 103 presents to client hosts 4 (or backup server 6) a single (virtual) directory tree 175 by aggregating a plurality of directory trees constructed in the local file system 102 in each file server 1A-1N. An example of a single directory tree 175 is shown in FIG. 4A and may be referred to as a “single namespace” in this embodiment. In directory tree 175, the file “b8”, for example, can be seen as being located under the directory “/hosta/a1/a4/b6”, and file “c5” can be seen as being located under the directory “/hosta/a2/c1”, even though these directories are actually located on file servers 1B and 1N, respectively.

An example of the operation between each client host 4 and file server 1A-1N is explained below. According to the present embodiment, network file system 103 uses NFSv4 protocol and uses the “migration function” supported by that protocol. First, each client host 4 mounts the file system using the following command:
mount hostA:/hosta/usr1

After the mount operation, client host 4 can access all the file system data in hosts 1A-1N, such as the directory tree shown in FIG. 4A whose root directory name (i.e., the directory name at the top of the directory hierarchy) is “/usr1”. When the user of client host 4 issues a request to see file (or directory) information of, for example, file (or directory) “a3” in FIG. 4A, the user issues the following command:
Is—al/usr1/a1/a3

This command is converted to a request in accordance with NFSv4 protocol by NFS client program 41, and the converted request is sent to host 1A. Supposing that the contents of the directory entry 121 of the directory “/hosta/a1” is as illustrated in FIG. 4B, when the network file system 103 in host 1A receives this request, as the i-node number 71 of the file/directory “a3” is ‘214’, it retrieves the i-node 114 whose i-node number 71 is ‘214’ from the metadata region 110 in the disk 32A-2 using local filesystem 102, and returns the information of the file (or directory) “a3” to client host 4. Then, when users want to see the information of directory “b6” in FIG. 4A, the user issues the following command:
Is—al/usr1/a1/a4/b6.

In the present embodiment, the information that the files/directories under the directory “a4” are managed by host 1B is stored in the directory entry 121. When the i-node number 71 in the directory entry 121 is ‘−1’, it means that the files/directories under the directory whose name is in the file/directory name field 81 is in another file server, and the necessary information to access another file server is described in the file/directory name field 81 as the format of ‘directory name’:‘hostname’:‘filesystem name’ (the top directory name in the target file server where the corresponding directory resides). In FIG. 4B, since the file/directory name field 81 at the bottom in the directory entry 121 is ‘a4:hostb:/hostb’, the network file system 103 in the file server 1A is able to determine that directory “a4” and the files/subdirectories under the directory “a4” are managed by host 1B. By referring to the directory entry 121 of the directory “a1”, host 1A sends a type of error code such as “NFS4ERR_MOVED” in accordance with NFSv4 protocol. At the same time, host 1A returns referral information regarding which of the hosts the directory “b6” currently resides in. In this case, the information of host 1B is returned to client host 4. When the NFS client program 41 of client host 4 receives this response, it reissues the NFS request to host 1B, and then retrieves attribute information of directory “b6”. In another embodiment, the above referral information of each file server may be cached in the memory 13 of each file server.

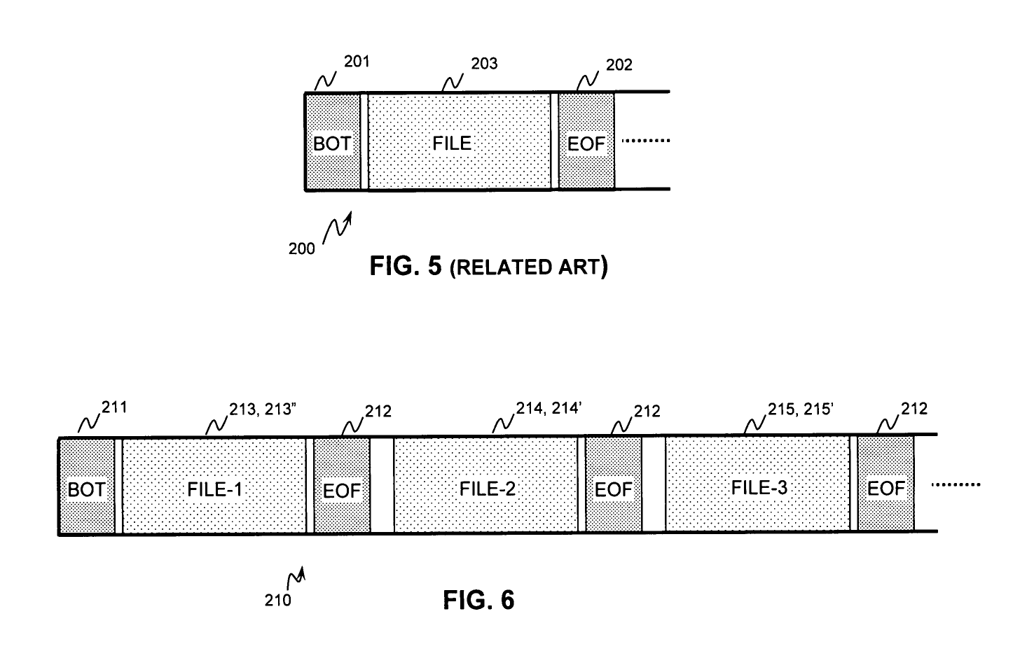

FIG. 5 illustrates a brief overview of how data is backed-up and stored to a tape device in the prior art. When a file server or NAS backs up data to a backup device such as a tape, the backup program in the file server or NAS reads the contents of the disk via a local file system, creates a single data stream in which the plurality of files and directories are connected as a single file (hereinafter the single data stream that the backup program creates is called an “archived file”), and writes the created single data stream into the tape device attached to the file server or NAS. A number of backup programs are known in the prior art such as “tar” or “dump” in the UNIX operating systems. As illustrated in FIG. 5, before writing an archived file, the mark Beginning of Tape (BOT) 201 is recorded at the beginning of a magnetic tape 200 and the archived file 203 (datastream) is stored as a single file. After writing the archived file, the mark End of File (EOF) 202 is recorded just after the file 203.

In this prior art backup method, the backup of the file system data is done using a single file server or a single NAS appliance. On the other hand, according to the present embodiment, since a single namespace is constructed over a plurality of file servers 1A-1N, the plurality of file servers 1A-1N need to backup data in the file system data that each is managing, and need to manage the backed-up data such that the backed up data from each of the files servers correlates with each other. Thus, in the present embodiment, a plurality of file system data are required to be backed-up in a single namespace which is composed of a plurality of file system data constructed across a plurality of file servers 1A-1N.

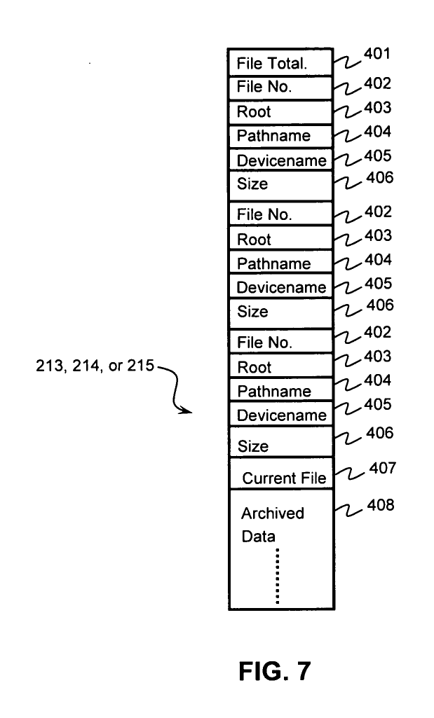

FIG. 6 illustrates an example of how backup data is stored to a tape 210 of a tape device according to the present embodiment. Since the top directory (root directory) of the single namespace is “/hosta” provided by file server 1A, the backup program 104 in the file server 1A creates backup data from disk 32A-1 and writes the archived file to tape device 7 as FILE-1 (213). The details of the format of FILE-1 (213) will be described later with reference to FIG. 7. After backup program 104 in file server 1A finishes writing the archived file to tape device 7, file server 1A issues a request to another file server 1B-1N to create backup data and to write the same to tape device 7.

This operation may be performed sequentially. For example, first, file server 1A issues a backup request to file server 1B and when the backup operation of file server 1B is completed, file server 1A issues the backup request to the next file server having namespace data until the request has finally been sent to file server 1N. Once this is accomplished, the backup operation of the single namespace is completed. On the magnetic tape media 210, FILE-1 (213) is first recorded following the beginning of the tape 211 and EOF 212 is written. Next, FILE-2 (214) is created by file server 1B, is recorded on tape 210, and EOF 201 is written thereafter. Next, FILE-3 (215) is created and written to tape 210 by the next file server containing files to be backed up, and finally, when all the data has been backed up, another EOF 212 is written to the tape.

FIG. 7 illustrates the format of the archived file in FILE-1 (213), FILE-2 (214), or FILE-3 (215). File Total 401 shows how many archived files are contained in the backup data of a single namespace. For example, when all of the files and directories in a single namespace shown in FIG. 4A are to be backed-up, since the single namespace has three file servers, three archived files are created. Thus, the File Total 401 would be 3.

Elements 402-406 are attribute information of the archived file. When a single namespace has multiple archived files, multiple sets of these elements are stored. In the example of FIG. 4A when a single namespace has three file servers, three sets of elements 402-406 are stored for each archived file. File No. 402 is an identification number of each archived file having backup data of the single namespace. The identification number is a non-negative integer. Root 403 stores the host name (or IP address) of the file server when the archived data is backed-up and stored. Pathname 404 stores the top directory name of the file system data that is backed-up to the archived file. The absolute pathname in a single namespace is stored as the top directory name. In the example of FIG. 4A, the file system data that host 1B creates is placed on “/hosta/a1/a4” in the single virtual namespace 175. Therefore, the pathname 404 for the archived file of host 1B is “/hosta/a1/a4”.

Devicename 405 is a device file name (such as “/dev/hda2”, “/dev/dsk/c1t0d0s2”, etc.) assigned to the disk 32 by driver 101 where the file system data corresponding to pathname 404 is stored. Size 406 represents the total size of the file system data that is backed-up as archived data. Current file 407 stores the file no. information of the archived file that is stored in the archived data field (element 408). Finally, archived data 408 is the data of the archived file. Various types of data formats can be used such as that used by the UNIX tar command.

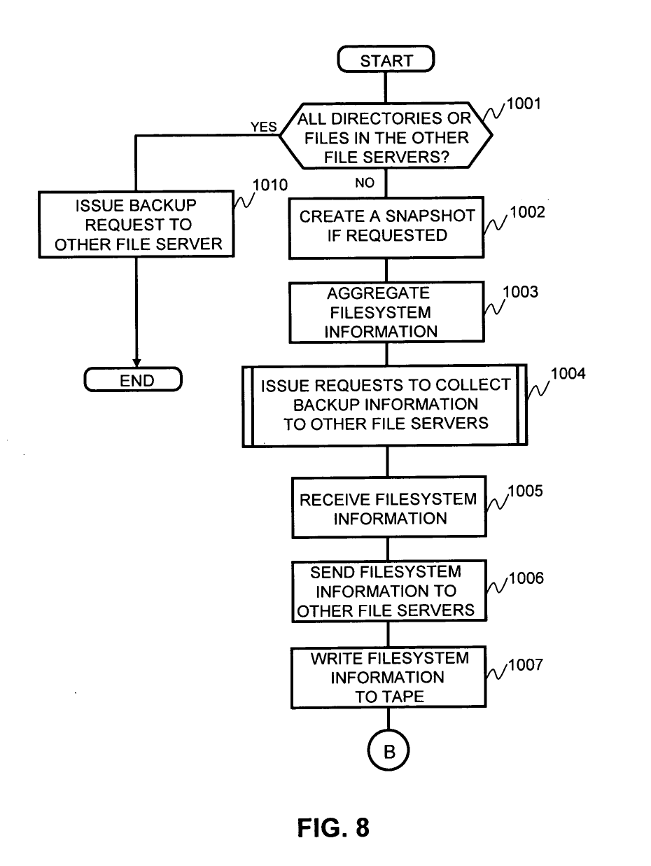

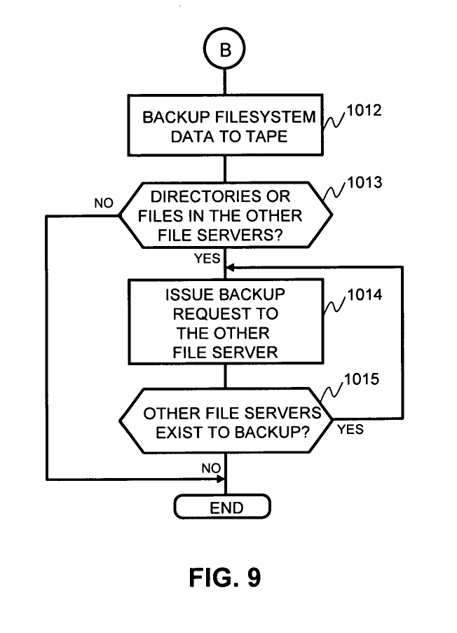

FIGS. 8, 9 and 10 illustrate a process flow of the backup operation carried out by the back up program 104 when a file server 1 receives a backup request from backup server 6. When backup manager 61 in backup server 6 issues such a request, backup manager 61 sends the top directory name of the file system or portion thereof for which a user wants to backup data, or, alternatively, sends a list of directory names. Still alternatively, if one or more files are desired to be backed-up, the file names may be sent. FIGS. 8 and 9 show examples of steps performed in a data backup method in which it is supposed that file server 1A receives a single backup request from backup manager 61. This process is equally applicable when one of the other file servers 1B-1N is the target of the backup request.

At step 1001, the process determines whether the file server 1A that received the request contains any of the directories or files specified in the request. It checks the directory entry 121 if the files or directories to be backed up are in the file server 1A or not. If all of the directories or files are in other file servers, the step proceeds to step 1010, and a backup request is issued to another file server by server 1A.

However, if the process determines that there are one or more files or directories managed by the file server 1A that received the request, the process proceeds to step 1002, where, if the backup manager 61 issues a request to create a snapshot of the file system data before backup, a snapshot is created. Thus, the invention also makes provision for creating snapshots for the namespace.

Next, at step 1003, the process collects information of file system data that is to be backed-up to create the attribute information for each file, such as file no. 402, root 403, pathname 404, devicename 405, and size 406 in FIG. 7.

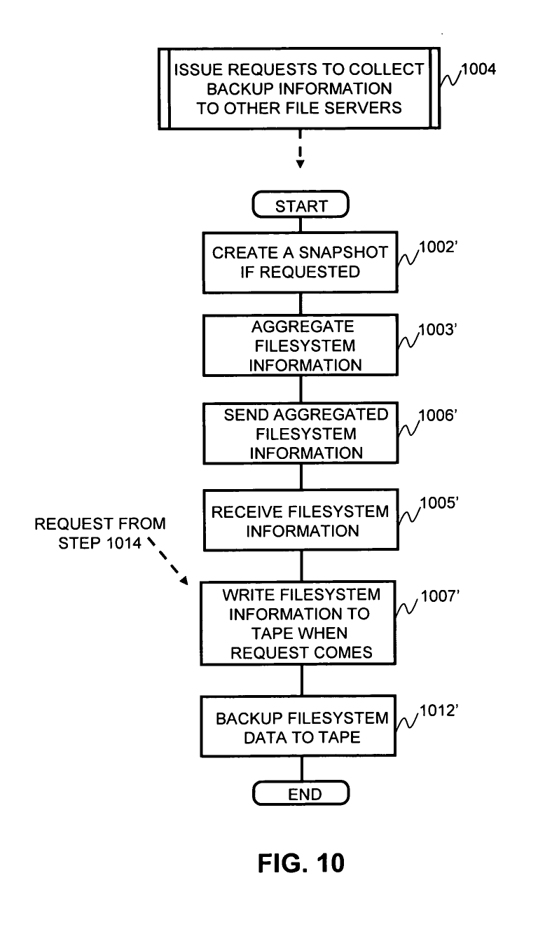

At step 1004, file server 1A issues requests to other file servers to collect backup information. When the other file servers receive this request, the backup programs in the other file servers perform steps 1002 and 1003, and send the collected information back to file server 1A. The details of the process that other file servers do are illustrated in FIG. 10, discussed below.

At step 1005, file server 1A receives the information collected by other file servers to which requests were issued.

At step 1006 file server 1A sends its own file system information to other file servers that may have requested this, if any.

At step 1007, the file system information (as described with reference to FIG. 7) received by file system 1A is written to tape.

Referring now to FIG. 9, continuing the process at step 1012, files or directories are read from the disk to create a data stream as an archived data format (for example using “tar” or “dump” in the UNIX operating system). The created data stream corresponds to element 407 in the backup data format. The created data stream is stored into the tape device following the file system information stored in step 1007.

At step 1013 the process determines whether there are other files or directories that are managed by other file servers that need to be backed up. If so, the process proceeds to step 1014. If not, the process ends.

At step 1014, the process issues a request to one of the other file servers to backup data by specifying the top directory name of the local file system data. Alternatively, when only backing up one or more files, the process specifies the list of file names to be backed-up. When the other file server receives the request, it executes the process described above with respect to step 1012 to create archived data by reading its disks and writing the archived data 408 to tape. After the backup operation finishes in the other file server, the other file server notifies file server 1A that the backup operation is finished. Upon receiving such notice at file server 1A, the process proceeds to step 1015.

At step 1015 the process determines if there are other file servers having additional files or directories that need to be backed-up and for which a backup operation has not been finished. If so, the process returns to step 1014 to issue a backup request to the second other file server where the additional files or directories are located. The requested second other file server performs the process described above for step 1012. When all of the file servers that need to back up data have finished backing-up the data, the process ends. Furthermore, according to a modified embodiment, step 1004 could be accomplished immediately after a snapshot is created in step 1002, and prior to data backup, in order to reduce the time lag in sequential creation of snapshots by the other servers.

FIG. 10 illustrates details of the process to collect backup information in the file server. This process is executed by the backup program 104 in the file servers that received the request from file server 1A (where the backup request is received from backup program 104) in response to the step 1004 of FIG. 8 executed in file server 1A. As shown in FIG. 10, at step 1002′ a snapshot is created if the backup manager 61 issues a request to create a snapshot of the file system data before backup. Then, at step 1003′ file system information is aggregated by collecting information of file system data that is to be backed-up to create the attribute information for each file, such as file no. 402, root 403, pathname 404, devicename 405, and size 406 in FIG. 7. At step 1006′ the aggregated file system information is sent to file server 1A. At step 1005′, file system information is received and the process is suspended until a request from file server 1A (at step 1014) arrives. Once the backup request arrives from step 1014 of FIG. 9, the file system information is written to tape at step 1007′. Then, at step 1012′, the specified data (files and or directories) is backed-up to tape and the process ends.

Additionally, in another embodiment, rather than having the first file server to receive the request send all the backup requests in a centralized fashion, the backup requests may be distributed from the first file server to a second file server, and from the second file server to a third file server, and so forth, until all data has been backed up. This may be accomplished in the process described above, by backup programs 104 on the other file servers. Thus, when the second file server receives the backup request from the first file server, instead of merely carrying out step 1012, the program may begin the process of FIGS. 8 and 9 at step 1001, with step 1015 being eliminated as being unnecessary. Thus, each file server in the file system will receive a backup request and backup data until all requested data has been backed up.

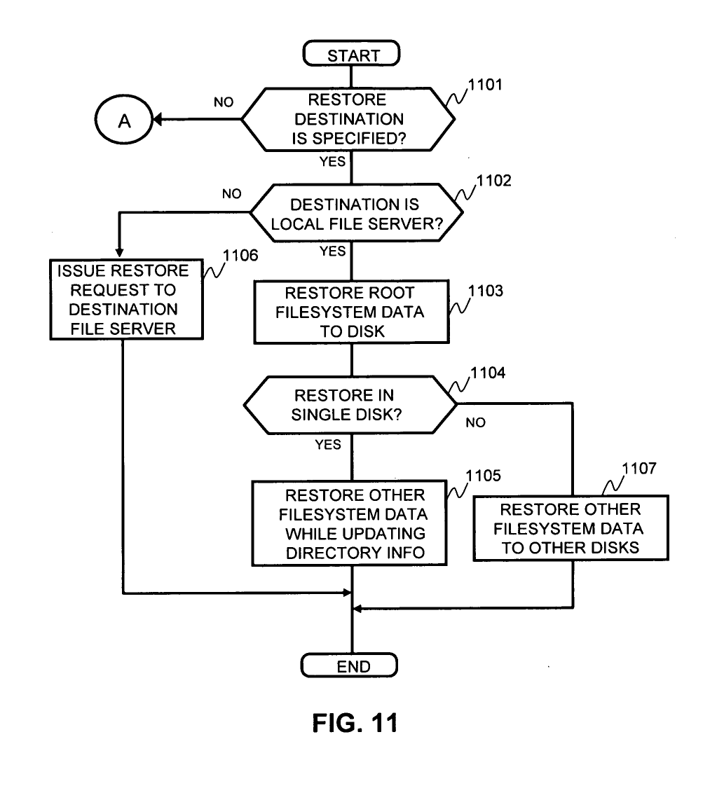

FIG. 11 illustrates a flowchart of the operation of restoring files or directories from the backup data after it has been backed up in the tape device. According to this embodiment, the backup manager 61 issues a restore request and provides the following information:

Restore destination of the backup data: The combination of the “file server name and device filename”, or directory name of the file system is specified. When the restored destination is not specified, the data is restored to the original location (the same location as when the backup was done).

Files or directories to be restored: When not all of the files or directories need to be restored, the backup manager 61 specifies which files or directories should be restored and the restore destination must be specified.

Number of disks: When the file system in a single namespace is backed-up, the data may be spread across multiple file servers (and multiple disks). When the total size of the backed-up data is less than the size of a disk, users can choose the option to restore data into a single disk 32 or to the same number of disks as were in use when backup was performed. For example, according to one embodiment, when providing information of the number of the disks for restoring data to, users can choose “0” or “1”. If “0” is chosen, it may mean that the number of disks to be restored is the same as when the backup was performed. If “1” is chosen, it may mean that data is to be restored to a single disk. Further, when “1” is chosen, the restore destination must be specified, and should be specified as the device filename.

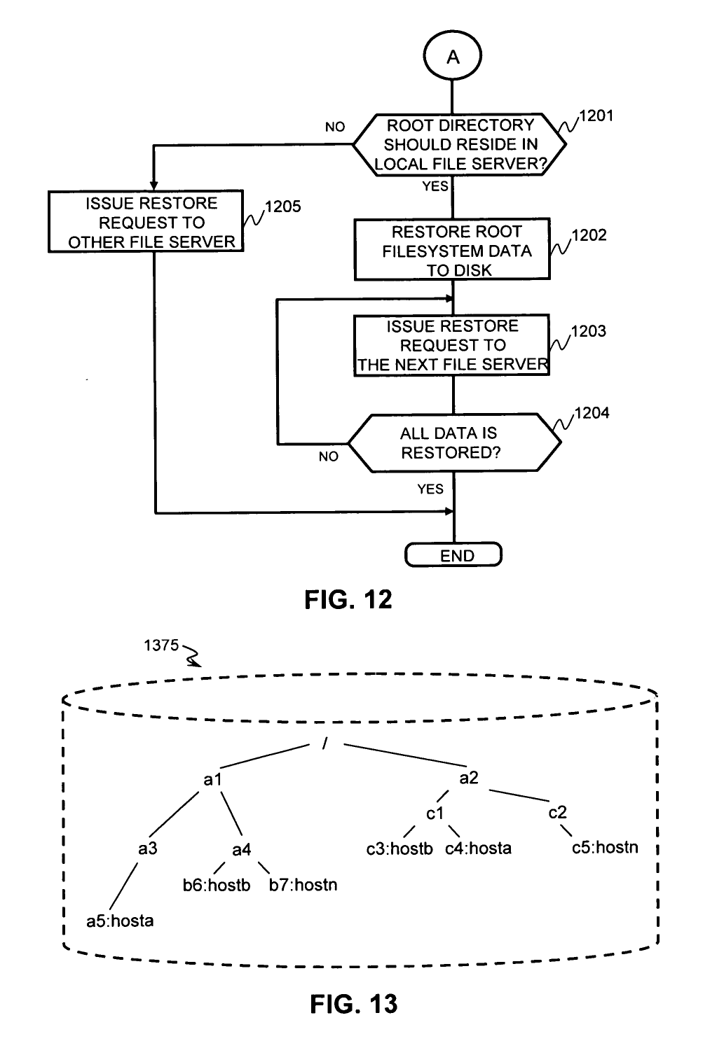

In FIG. 11, at step 1101, backup program 104 on the file server that received the restore request determines if the restore destination is specified. If the restore destination is specified, the process proceeds to step 1102. If the restore destination is not specified, the data is to be restored to the original location (i.e., the location from which it was originally backed up), and the process goes to step 1201 in FIG. 12.

At step 1102 it is determined whether the restore destination is in the file server that received the restore request. If so, the process proceeds to step 1103, if not, the process proceeds to step 1106.

At step 1103, the file system data that are placed just under the root directory in the single directory tree 175 is restored to the disk. In the example of FIG. 4, as the file system data that resides in the disk 32A-1 (directory a1, a3, . . . ) is placed at the highest location in the single directory tree 175, archived file that includes the file system data that was backed up from disk 32A-1 is chosen to restore to the disk from the archived file 213, 214, or 215 at first. To find which archived file is to be restored at first, backup program 104 checks the Pathname 404. When needed, the backup program 104 rewinds the tape to read the appropriate archived data.

At step 1104, the process determines if the number of disks to be restored is specified. If the process determines that data should be restored to a single disk the process proceeds to step 1105. If not, the process proceeds to step 1107.

At step 1105, the process restores the backup data into the same disk. In this case, some of the directory name information will need to be changed or updated. For example, when restoring data that host 1B had managed (b6, b7, b8 . . . ) into the same disk as the directories a1, a3 . . . , the directory information of a4 needs to be updated. Then, the directories or files (b6, b7, b8 . . . ) may be placed under directory a4.

Step 1106 a restore request is issued to the destination file server by the local server if the local server is determined not to be the destination to which the data is to be restored. When the destination file server receives the request the destination file server starts processing at step 1101 in FIG. 11.

At step 1107, the process restores the backup data into other disks. At step 1102, if the destination is not the local file server, the restore request is issued to the destination file server.

Referring now to FIG. 12, at step 1201, it is determined if the root directory resides in the file server that receives the backup request. If so, the process proceeds to step 1202. If not, the process proceeds to step 1205.

At step 1202, a process similar to that at step 1103 of restoring the root file system data to the disk is performed.

At step 1203, a restore request is issued to the next file server. For example, when a second archived file that is stored in the tape device was originally backed-up by file server 1B, the process issues a restore request to file server 1B. After the restore operation is finished restoring data in the file server that received the restore request, the process receives notification that the restore by the other file server is completed. After receiving such notification, the process proceeds to step 1204.

At step 1204, it is determined whether all of the data is restored. If not, the process returns to step 1203 so that the restore request can be issued to the next file server. If all of the data is restored, the process ends.

Step 1205 is similar to step 1203 in that it issues a restore request to another file server. When the other file server receives the request the other file server starts processing at step 1101 in FIG. 11.

### Additional Embodiment

In the above embodiments, the description was based on a file server system that creates a single namespace in accordance with NFSv4 protocol. However, the present invention is also applicable to other clustered file systems. FIG. 13 illustrates another example of a single namespace 1375 according to another embodiment. In the namespace illustrated in FIG. 13, local file system 102 and network file system 103 (FIG. 2) manage in which file server each of the files is placed. The information regarding in which file server each of the files is placed is stored in the file attribute information (i-node). For example, the file “b6” may be placed on file server host 1B and file “b7” may be placed on file server host 1N. In such a case, since each file under the same directory (for example, “/a1/a4”) is managed by different file servers, the backup program 104 must backup the location of each file when it backs up the file system data.

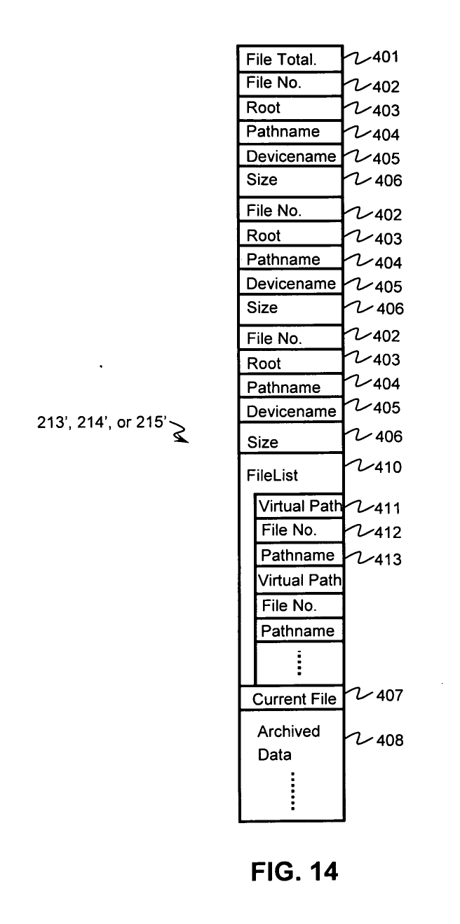

FIG. 14 shows an example format of the archived file 213′, 214′ or 215′ according to the additional embodiment. Elements 401-408 are the same as described in FIG. 7. However, in this additional embodiment, file list 410 is added in the archived file format. File list 410 has multiple sets of file information to be backed up, namely, each set of file information includes a virtual path 411, a file No. 412, and a pathname 413. Virtual path 411 is the absolute pathname in a single namespace of the file to be backed-up. For example, the virtual path 411 of file “b6” in FIG. 12 is “/a1/a4/b6”, although it may be stored under a different directory in file server 1B. File No. 412 shows in which archived file each file is stored. When files and directories under host 1B are backed-up into the archived file whose file number 402 is “1”, the file No.412 should be “1”. Pathname 413 is the pathname of the local file system data. With the exception of adding the file list 410 before the archived data 408, the methods of backup and restore discussed above are the same for this embodiment as in the previous embodiments, and the data files, are stored to the backup device in the same manner, such as 213′, 214′ and 215′ illustrated in FIG. 6.

Thus, it may be seen that the present invention sets forth a simplified backup operation for users or client hosts in clustered file systems. A single backup command may be issued to a server to cause all files in a namespace spread across multiple storages to be automatically located and backed up. Further, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. In a clustered file system having a plurality of file servers each having a network file system, the network file system of each file server communicating with one another so as to provide a client host with a single directory tree, a method of backing-up data in the clustered file system comprising the steps of:
(a) receiving a back-up request at a first file server of said file servers;
(b) copying data managed by the first file server onto a back-up storage device;
(c) sending a request to a second file server of said file servers to cause that file server to copy data managed by that file server onto the back-up storage device; and
(d) repeating step (c) for each of the plurality of file servers until all of the data referenced in said single directory tree is copied onto the back-up storage device.

2. The method according to claim 1, wherein the clustered file system is a clustered network attached storage (NAS) system.

3. The method according to claim 1, wherein, once all of the data is copied to the back-up storage device, the back-up storage device contains one archived file for each of the plurality of file servers such that the total number of archived files is equal to the number of file servers.

4. The method according to claim 1, wherein there back-up storage is a tape drive.

5. The method according to claim 1, further including the step of issuing a request by the first file server to collect backup information from each of said plurality of file servers;
receiving file system information from said plurality of file servers; and
writing said file system information to the back-up storage device.

6. The method according to claim 5, wherein file attribute information is stored relating on which server of said plurality of servers a file is stored, and
said file system information includes a file list, said file list including, for each file to be backed up on a server:
a virtual path as an absolute path name of the file to be backed up; and
a path name of the file to be backed up in a local file system for each of said plurality of file servers.

7. The method according to claim 1, further including the step of:
creating a snapshot of the data managed by the first file server prior to copying the data managed by the first file server to the back-up storage device.

8. The method according to claim 1, further including the step of
sending a request by said second file server to a third file server of said file servers to cause the third file server to copy data managed by the third file server onto the back-up storage device.

9. In a clustered file system having a plurality of file servers each having a network file system, the network file system of each file server communicating with one another so as to provide a client host with a single directory tree, a method of backing-up data in the clustered file system comprising the steps of:
(a) receiving, at a first file server, a request to back-up files managed by at least the first file server and a second file server;
(b) creating a snapshot of the data in a first file system of the first file server;
(c) copying data of the first file system to a back-up storage device;
(d) creating a snapshot of the data in a second file system of the second file server; and
(e) copying data of the second file system to the back-up storage device;

10. The method according to claim 9, wherein, after step (c), the first file server sends a back-up request to the second file server.

11. The method according to claim 9, wherein before step (b), the first file server sends a back-up request to the second file server.

12. The method according to claim 9, wherein during step (b), the first file server sends a back-up request to the second file server.

13. The method according to claim 9, wherein step (e) is performed after the second file server receives an instruction from the first file server.

14. The method according to claim 9, wherein, when all of the data is copied to the back-up storage device, the back-up storage device contains one archived file for each of the first and second file servers such there are two archived files stored on the back-up storage device.

15. A clustered file system comprising:
a plurality of file servers;
a plurality of storage devices coupled to the plurality of file servers;
a plurality of files stored in the plurality of storage devices, the plurality of files being presented to a client host in a single namespace; and
wherein, in order to back-up data of files in the clustered file system, the client host issues a back-up request to one of the file servers, wherein said one file server receiving the request transmits a back up request to one or more other of said file servers until data is completely backed up.

16. The clustered file system according to claim 15, wherein each file server includes a local file system and a network file system, and wherein the network file systems of the file servers communicate with one another to provide the single namespace to the client host.

17. The clustered file system according to claim 15, further comprising a back-up storage device which stores the back-up data of the files.

18. The clustered file system according to claim 17, wherein the back-up storage device, file servers and the storage devices are interconnected via a fibre channel (FC) switch.

19. A method for restoring backup data in a system including a plurality of file servers, said plurality of file servers connected by a network and storing data of a single namespace in a divided fashion among said file servers, said backup data having been stored in separate files according to how the data of said namespace is stored on said file servers, said method comprising:
receiving a restore request by a first one of said file servers;
determining whether a restore destination is in said first file server;
if the restore destination is not in said first file server, issuing by the first file server another restore request to a second one of said file servers.

20. The method of claim 19, further including the step of:
when one of said file servers receiving a restore request is also the destination of the received restore request, that file server restores data of said backup data corresponding to a root file system to a local file system on that file server.

21. The method of claim 20, further including the step of:
determining whether restore is requested to a single disk; and
if restore is not requested to a single disk, restoring file system data from the backup data to other disks.
